(19) United States
(12) Patent Application Publication
(10) Pub. No.: US 2022/0113140 A1
(43) Pub. Date: Apr. 14, 2022

(54) AUTONOMOUS DRIVING SYSTEM AND METHOD OF GENERATING DETAILED MAP THEREOF

(71) Applicants: HYUNDAI MOTOR COMPANY, Seoul (KR); KIA CORPORATION, Seoul (KR)

(72) Inventors: Sung Won YOON, Yongin-si (KR); Jeong Hun KIM, Seoul (KR)

(73) Assignees: HYUNDAI MOTOR COMPANY, Seoul (KR); KIA CORPORATION, Seoul (KR)

(21) Appl. No.: 17/409,172

(22) Filed: Aug. 23, 2021

(30) Foreign Application Priority Data
Oct. 8, 2020 (KR) 10-2020-0130440

(51) Int. Cl. G01C 21/30; G01C 21/00

(52) U.S. Cl. CPC G01C 21/30; G01C 21/3804

(57) ABSTRACT

An autonomous driving system includes a sensor unit installed in a vehicle and configured to sense first external information, an information provider configured to provide second external information required for autonomous driving, a vehicle driving unit configured to drive the vehicle, a controller configured to process the first external information and the second external information and to control the vehicle driver, and a detailed map transmission system configured to provide a detailed map of the controller, wherein the detailed map transmission system provides an initial map generated based on current positioning data of the vehicle in a stationary state, to the controller, receives a corrected positioning data from the controller, generates the detailed map, and provides the detailed map to the controller.

### CROSS-REFERENCE TO RELATED APPLICATION

This application claims priority to and the benefit of Korean Patent Application No. 10-2020-0130440, filed on Oct. 8, 2020, which is hereby incorporated by reference as if fully set forth herein.

### TECHNICAL FIELD

The present disclosure relates to an autonomous driving system, and more particularly to an autonomous driving system and a method of generating a detailed map thereof for correcting positioning and transmitting a detailed map based on information on an initial map of a stopped vehicle.

### BACKGROUND

An autonomous vehicle corresponds to a combination of intelligence vehicle technologies and is capable of generating the current position or an optimal path to a destination and is capable of traveling without special manipulation after a driver rides in a vehicle and determines the desired destination.

The autonomous vehicle may actively prevent accidents by recognizing a traffic signal or a sign on a road, maintaining an appropriate speed according to a traffic flow, and recognizing a dangerous situation, and may travel to a desired destination while appropriating steering the vehicle in order to autonomously maintain a lane and to change a lane, to overtake another vehicle, and to avoid an obstacle as necessary.

Along with development of the autonomous vehicle, many researches have been conducted into technology of estimating the position of the autonomous vehicle. In general, a global navigation satellite system (GNSS) has been largely used to estimate the position of the autonomous vehicle. Even if the technology of estimating the position of the autonomous vehicle is used, the driver frequently drives the vehicle by a predetermined distance to match a direction of the vehicle with a travel direction on a road and then calculates a normal target path. Even in an unmanned autonomous system, a vehicle is driven without a person, and thus the vehicle is autonomously driven after positioning reaches a relatively reliable section by manually driving the vehicle in a predetermined section as if there is a user, and thus a method of transmitting information on a new map may be desirable.

### SUMMARY

The present disclosure provides an autonomous driving system and a method of generating a detailed map using the same for estimating positioning of a stationary vehicle with high accuracy.

The present disclosure also provides an autonomous driving system and a method of generating a detailed map for acquiring information on positioning with high accuracy through error correction.

In an aspect, the present disclosure provides an autonomous driving system includes a sensor unit installed in a vehicle and configured to sense various pieces of first external information, an information provider configured to provide various pieces of second external information required for autonomous driving, a vehicle driving unit configured to drive the vehicle, a controller configured to process the first and second external information provided from the sensor unit and the information provider and to control the vehicle driver, and a detailed map transmission system configured to provide a detailed map to the controller, wherein the detailed map transmission system provides an initial map generated based on current positioning data of the vehicle in a stationary state, provided from the information provider, to the controller, receives a corrected positioning data from the controller, generates a detailed map, and provides the detailed map to the controller, and the controller generates a temporary map based on sensing data provided from the sensor unit, matches the temporary map with the initial map received from detailed map transmission system, corrects a positioning data, and provides the corrected positioning data to the detailed map transmission system.

The detailed map transmission system may generate the initial map based on a most probable path (MPP) based on the current positioning data provided from the information provider.

The detailed map transmission system may configure a most probable path (MPP) based on direction information only of the current positioning data, or may configure a most probable path (MPP) using only positioning information except for the direction information of the current positioning data.

The sensor unit may include a light detection and ranging (Lidar) configured to emit a laser pulse, and to receive light that is reflected by and returns from a target object around the emitted light to measure a distance, an altitude, and a direction of the object, a radio detection and ranging (radar) configured to transmit a radio wave, and to receive a signal of the reflected radio wave to measure the distance, the altitude, and the direction of the object when the transmitted radio wave is reflected by a nearby structure, a camera configured to generate an image of an outside of the vehicle, and an ultrasonic sensor configured to transmit an ultrasonic wave, and to receive a reflected signal to measure the distance, the altitude, and the direction of the object when the transmitted wave is reflected by a nearby structure.

The autonomous driving system may further include a communicator configured to receive destination information from an outside and to provide the destination information to the controller.

The communicator may include a mobile communication module configured to perform data communication using any one of communication methods of CDMA, GSM, and LTE, a wireless Internet module configured to perform wireless Internet communication using any one of methods of WLAN, Wibro, and Wimax, and a short-distance communication module configured to perform short-distance wireless communication using any one of communication methods of Bluetooth, NFC, RFID, IrDA, or Zigbee.

The autonomous driving system may further include a user interface unit configured to receive destination data from a user, to provide the destination data to the controller, and to display the detailed map received from the detailed map transmission system to the user.

The user interface unit may include an input unit configured to receive an input signal of the user and to transmit the input signal to the controller, a display unit configured to display various information provided from the controller in a form of an image to be recognized by the user, a microphone configured to transmit information on user voice to the controller, and a sound output unit configured to output the information provided from the controller in a form of an audio signal to be recognized by the user.

The information provider may include a global positioning system (GPS) module configured to receive a signal transmitted from a satellite, and to calculate current position data of the vehicle, a vehicle to everything communication (V2X) module configured to exchange information using a wireless and wired method based on the vehicle and to transmit the information to the controller, a geographical information provider configured to provide geographical information required for an operation of the detailed map transmission system, and a traffic information provider configured to receive various pieces of traffic information provided from an outside and to transmit the traffic information to the controller.

In another aspect, method of generating a detailed map of an autonomous driving system, performed by a detailed map transmission system in an autonomous driving system, the method includes acquiring destination information, receiving current positioning data of a vehicle in a stationary state, generating and transmitting an initial map based on the current positioning data, receiving positioning data corrected by matching the initial map and a temporary map generated using data acquired from a sensor unit of the vehicle, and resetting the initial map based on the corrected positioning data and generating and transmitting the detailed map.

### DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIGS. 1A, 1B, 1C, and 1D are diagrams showing an example of the case to be considered depending on a relationship between the position and the travelling direction of a vehicle in a general map information transmission system;

FIG. 2 is a schematic block diagram showing the configuration of an autonomous driving system in one form of the present disclosure;

FIG. 3 is a schematic block diagram showing the configuration of a sensor unit of an autonomous driving system in one form of the present disclosure;

FIG. 4 is a schematic block diagram showing the configuration of a communicator of an autonomous driving system in one form of the present disclosure;

FIG. 5 is a schematic block diagram showing the configuration of a user interface unit of an autonomous driving system in one form of the present disclosure;

FIG. 6 is a schematic block diagram showing the configuration of an information provider of an autonomous driving system in one form of the present disclosure;

FIG. 7 is a diagram showing an example of a time-series operation relationship between components of an autonomous driving system in one form of the present disclosure;

FIGS. 8A, 8B, and 8C are diagrams showing an example of an initial map, a temporary map, and a detailed map generated by an autonomous driving system in one form of the present disclosure; and

FIG. 9 is a flowchart showing an operation of a detailed map transmission system of an autonomous driving system in one form of the present disclosure.

### DETAILED DESCRIPTION

In some forms of the present disclosure, specific structural and functional descriptions are merely illustrated for the purpose of illustrating embodiments of the disclosure and exemplary embodiments of the present disclosure may be embodied in many forms and are not limited to the embodiments set forth herein.

Exemplary embodiments of the present disclosure can be variously changed and embodied in various forms, in which illustrative embodiments of the disclosure are shown. However, exemplary embodiments of the present disclosure should not be construed as being limited to the embodiments set forth herein and any changes, equivalents or alternatives which are within the spirit and scope of the present disclosure should be understood as falling within the scope of the disclosure.

It will be understood that although the terms first, second, third etc. may be used herein to describe various elements, these elements should not be limited by these terms. These terms are only used to distinguish one element from another element. For example, a first element may be termed a second element and a second element may be termed a first element without departing from the teachings of the present disclosure.

It will be understood that when an element, such as a layer, a region, or a substrate, is referred to as being “on”, “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Other words used to describe the relationship between elements or layers should be interpreted in a like fashion, e.g., “between,” versus “directly between,” “adjacent,” versus “directly adjacent,” etc.

The terms used in the present specification are used for explaining a specific exemplary embodiment, not limiting the present disclosure. Thus, the singular expressions in the present specification include the plural expressions unless clearly specified otherwise in context. Also, terms such as “include” or “comprise” may be construed to denote a certain characteristic, number, step, operation, constituent element, or combination thereof, but may not be construed to exclude the existence of or possibility of addition of one or more other characteristics, numbers, steps, operations, constituent elements, or combinations thereof.

Unless otherwise defined, all terms including technical and scientific terms used herein have the same meaning as commonly understood by one of ordinary skill in the art to which this present disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When an embodiment is differently implemented, a function or an operation stated in a specific block may be performed in a different way from an order of a flowchart. For example, actually, two consecutive blocks may be substantially simultaneously performed, or depending on a related function or operation, the blocks may also be reversely performed.

Hereinafter, an autonomous driving system and a method of generating a detailed map in some forms of the present disclosure will be described with reference to the accompanying drawings.

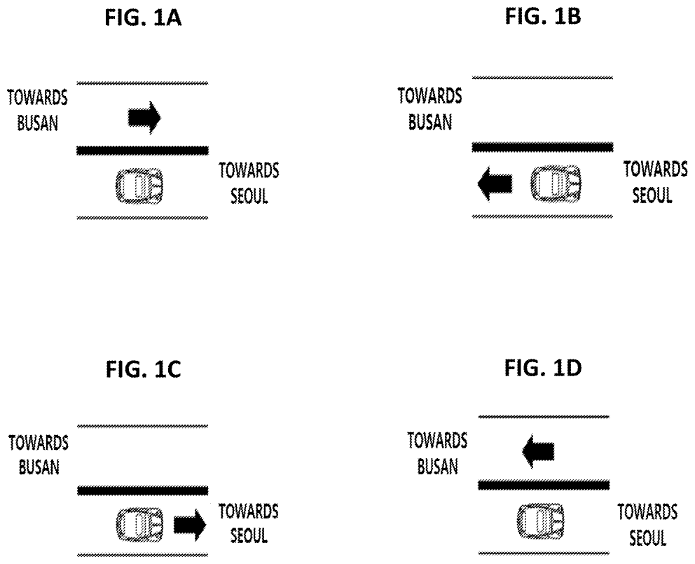

FIG. 1 is a diagram showing an example of the case to be considered depending on a relationship between the position and the travelling direction of a vehicle in a general map information transmission system. There may be cases including a vehicle travels towards Seoul in an opposite lane to a lane of a stopped vehicle on a road towards Seoul shown in FIG. 1A, a vehicle travels towards Busan in the same lane as a value that stops on a road towards Seoul shown in FIG. 1B, a vehicle travels towards Seoul in the same lane as a stopped vehicle on a road towards Seoul shown in FIG. 1C, and a value travels towards Busan in an opposite lane to that of a stopped vehicle on a road towards Seoul shown in FIG. 1D.

In the general map information transmission system, FIG. 1A and FIG. 1B may be determined to be the state in which a vehicle is not capable of traveling, and map information to a destination may not be transmitted to a controller or information containing a different path from an actual path may be transmitted to the controller. The two cases may be problematic, and thus an unmanned autonomous system may not transmit map information with respect to the two conditions.

The autonomous driving system in some forms of the present disclosure may determine even the cases shown in FIG. 1A and FIG. 1B as a case that is the closest to the case shown in FIG. 1C or FIG. 1D in which it is possible to transmit input information on positioning of a vehicle and may transmit the destination information to a controller in the case shown in FIG. 1C or FIG. 1D. That is, there is no case in which it is impossible to transmit the information on positioning.

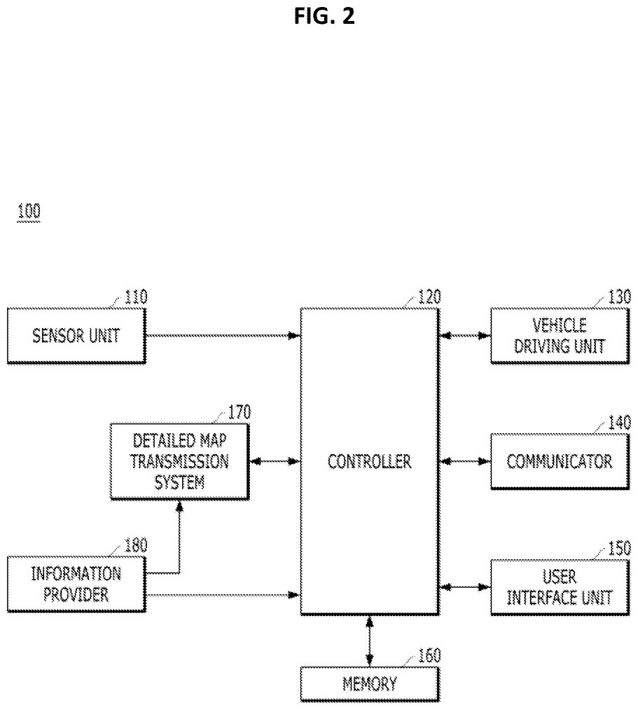

FIG. 2 is a schematic block diagram showing the configuration of an autonomous driving system in some forms of the present disclosure. As shown in the drawing, the autonomous driving system may include a sensor unit 110, a controller 120, a vehicle driving unit 130, a communicator 140, a user interface unit 150, a memory 160, a detailed map transmission system 170, and an information provider 180.

The sensor unit 110 may be installed in various forms in a vehicle and may provide the sensed first external information to the controller 120.

The information provider 180 may provide various pieces of second external information required for autonomous driving to the detailed map transmission system 170 and the controller 120.

The vehicle driving unit 130 may drive the vehicle according to a control signal of the controller 120.

The controller 120 may process the first external information provided from the sensor unit 110, the detailed map transmission system 170, and the information provider 180 and may control the overall operation of the vehicle, such as the vehicle driving unit 130. The controller 120 may be embodied as at least one of application specific integrated circuit (ASIC), digital signal processor (DSP), programmable logic devices (PLD), field programmable gate arrays (FPGAs), central processing unit (CPU), microcontrollers, and microprocessors.

The detailed map transmission system 170 may generate an initial map based on data received from the information provider 180, may generate a detailed map based on positioning correction information received from the controller 120, and may transmit the detailed map to the controller 120.

The communicator 140 may receive destination information from the outside using a wireless communication method and may provide the destination information to the controller 120.

The user interface unit 150 may receive data of the destination from a user, may provide the data to the controller 120, and may display the detailed map received from the detailed map transmission system 170 to the user according to the control signal of the controller 120.

The memory 160 may store temporary data based on an operation of the controller 120 or may include various application programs driven by the controller 120. The memory 160 may be embodied as at least one of storage media (recording media) including a flash memory, a hard disk, a secure digital (SD) card, random access memory (RAM), static random access memory (SRAM), read only memory (ROM), programmable read only memory (PROM), electrically erasable and programmable ROM (EEPROM), erasable and programmable ROM (EPROM), a register, detachable-type disk, and a web storage.

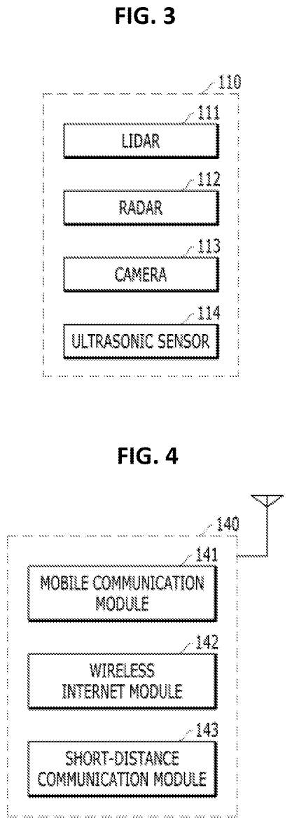

FIG. 3 is a schematic block diagram showing the configuration of the sensor unit 110 of an autonomous driving system in some forms of the present disclosure. The sensor unit 110 may include at least one sensor for recognizing at least one of information on a facility installed around a road, and information on an environment around the road.

As shown in the drawing, the sensor unit in some forms of the present disclosure may include a light detection and ranging (Lidar) 111, a radio detection and ranging (radar) 112, a camera 113, and an ultrasonic sensor 114.

The LiDAR 111 may emit a laser pulse, and may receive light that is reflected by and returns from a target object around the emitted light to measure a distance, an altitude, and a direction of the object.

The radar 112 may transmit a radio wave, and when the transmitted radio wave is reflected by a nearby structure, the radar 112 may receive a signal of the reflected radio wave to measure a distance, an altitude, and a direction of the object.

The camera 113 may generate image data by photographing a front side, a rear side, and right and left lateral sides of the vehicle.

The ultrasonic sensor 114 may transmit an ultrasonic wave, and when the transmitted wave is reflected by a nearby structure, the ultrasonic sensor 114 may receive the reflected signal to measure a distance, an altitude, and a direction of the object.

Although not shown, the ultrasonic sensor 114 may further include various sensors. For example, the ultrasonic sensor 114 may include an in-vehicle that is positioned in a vehicle and monitors the state of a driver, a plurality of sensors installed at forward, rear, right, and left sides of the vehicle and detects proximity of an object, an impact sensor that senses an environment around the vehicle, e.g., impact applied to the vehicle, illumination, or humidity and provides first external information required to control a vehicle controller to a controller, an illumination sensor, a humidity sensor, or the like. In addition, the ultrasonic sensor 114 may calculate the moving distance and direction of the vehicle using a sensor value measured through a gyro sensor, a speed sensor, an acceleration sensor, or the like and may provide the calculated value to the controller 120.

FIG. 4 is a schematic block diagram showing the configuration of the communicator 140 of an autonomous driving system in some forms of the present disclosure. As shown in the drawing, the communicator 140 may include a mobile communication module 141, a wireless Internet module 142, and a short-distance communication module 143.

The mobile communication module 141 may perform data communication with an external device using any one of communication methods such as CDMA, GSM, or LTE.

The wireless Internet module 142 may perform wireless Internet communication using any one of methods such as WLAN, Wibro, and Wimax. The short-distance communication module 143 may perform wireless communication with a device positioned at a short distance using any one of wireless communication methods such as Bluetooth, NFC, RFID, IrDA, and Zigbee.

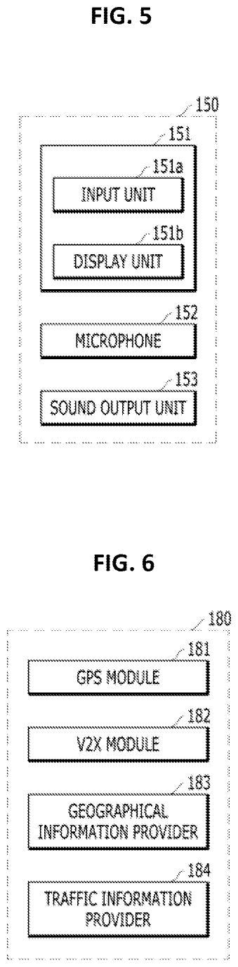

FIG. 5 is a schematic block diagram showing the configuration of the user interface unit 150 of an autonomous driving system in some forms of the present disclosure. As shown in the drawing, the user interface unit 150 may include an input unit 151a, a display unit 151b, a microphone 152, and a sound output unit 153.

The input unit 151a may perform a function of receiving an input signal of a user and transmitting the same to the controller 120.

The display unit 151b may display information provided from the controller 120 in the form of an image to be recognized by the user. In detail, the input unit 151a and the display unit 151b may be embodied in the form of a touch panel, may display a key-input image through the display unit 151b, and may allow the user to input destination information.

The microphone 152 may transmit destination information on user voice to the controller 120. Depending on the case, a separate voice recognition application may be embodied to recognize a signal of the user voice through the microphone 152 and to generate data of the destination.

The sound output unit 153 may output information provided from the controller 120 in the form of an audio signal to be recognized by the user. For example, information on a nearby environment, information on current driving, traffic information, or the like may be provided to the user. In addition, the sound output unit 153 may include a gesture detection module that is installed in a vehicle and recognizes a user gesture in the form of a user input signal. Depending on the case, the sound output unit 153 may include a gaze recognizer for recognizing a user gaze in the form of a user input signal or a device for recognizing the user input signal in the form of a joystick.

FIG. 6 is a schematic block diagram showing the configuration of the information provider 180 of an autonomous driving system in some forms of the present disclosure. AS shown in the drawing, the information provider 180 may include a global positioning system (GPS) module 181, a vehicle to everything communication (V2X) module 182, a geographical information provider 183, and a traffic information provider 184.

The GPS module 181 may receive a signal transmitted from a satellite, may calculate information on the current position of the vehicle, and may transmit the calculated information to the detailed map transmission system 170. The V2X module 182 may exchange information using a wireless and wired method and may exchange the information to the controller 120. Vehicle to everything communication (V2X) may refer to technology of communicating with various elements on a road to allow the vehicle to autonomously drive.

The V2X module 182 may be configured by vehicle to vehicle (V2V) between vehicles, vehicle to infrastructure (V2I) for communication with a traffic infrastructure such as a signal lamp, a vehicle to pedestrian (V2P) for supporting information on a pedestrian, or the like.

The geographical information provider 183 may provide geographical information system (GIG) require for an operation of the detailed map transmission system 170.

The traffic information provider 184 may receive various pieces of traffic information provided from the outside and may transmit the information to the controller 120. For example, the information may include information on a traffic situation, information on a traffic volume, information on weather, and the like.

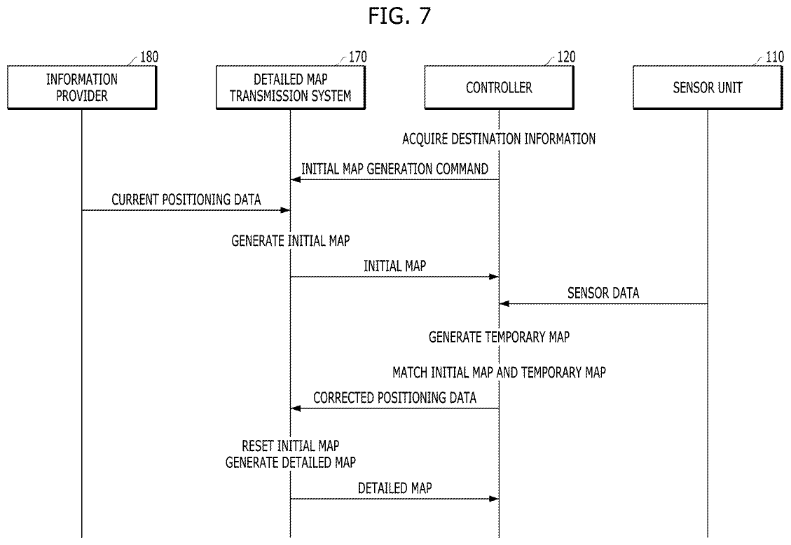

FIG. 7 is a diagram showing an example of a time-series operation relationship between components of an autonomous driving system in some forms of the present disclosure. First, the controller 120 may acquire destination information. The autonomous driving system in some forms of the present disclosure may also be applied when a user rides in a stationary vehicle or to a stationary unmanned autonomous vehicle. When the user rides in the vehicle, the user may input the destination information through a touch panel of a navigation device, or when a voice recognition function application is driven, the user may input the destination information through a microphone. The present disclosure may be applied to the case in which an unmanned autonomous vehicle stops at an arbitrary place. The destination information may be provided along with a driving control signal to a communicator of the unmanned autonomous vehicle using a mobile communication method or a wireless Internet communication method from the outside.

The controller 120 that acquires the destination information may transmit a command for generating an initial map along with the destination information received from the detailed map transmission system 170.

The detailed map transmission system 170 that receives the command for generating the initial map may receive the current positioning data required to generate the initial map from the information provider 180.

The detailed map transmission system 170 may generate the initial map using the current positioning data provided by the GPS module 181 from the information provider 180. A conventional autonomous driving system may make a request for an initial map in the state in which the accurate positioning of the vehicle is known or may not provide the initial map to a controller in the state in which the accurate positioning of the vehicle is not known. This is because a vehicle is positioned in an opposite direction to a destination due to the inaccuracy of the position and direction of the vehicle or the vehicle is positioned in an opposite lane or at a position that is not a road. However, in some forms of the present disclosure, the initial map may be generated based on the most probable path (MPP) using the current positioning, for example, information on the position and direction of the vehicle in the state in which the accurate positioning of the vehicle is not known. A detailed map transmission system may configure the most probable map (MPP) based on direction information only of the current positioning data or may configure the most probable path (MPP) using only position information except for direction information of the current positioning data.

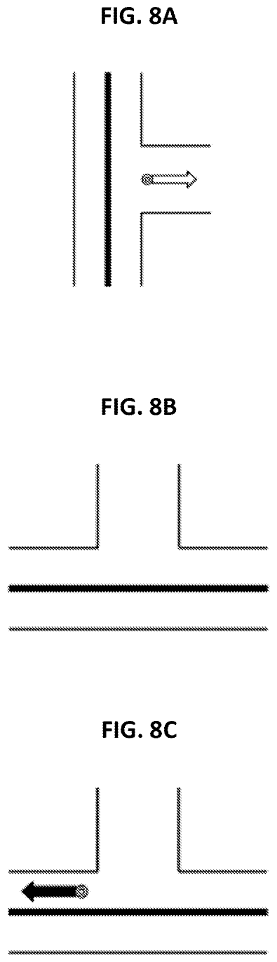

The detailed map transmission system 170 may transmit the generated initial map to the controller 120. The initial map may be shown in FIG. 8A.

The controller 120 that receives information on an initial map from the detailed map transmission system 170 may receive sensing data from the sensor unit 110. In this case, the sensing data may include information on images of forward, rear, right, and left sides of the vehicle, received from the camera 113, and information on the position and distance of an object, provided from the radar 112, the ultrasonic sensor 114, or the like.

The controller 120 may generate a temporary map using the received sensing data. The temporary map may be shown in FIG. 8B.

The controller 120 may match the temporary map with the initial map received from the detailed map transmission system 170, may correct positioning data according to the matching result, and may transmit the corrected positioning data to the detailed map transmission system 170.

Positioning of the vehicle may be corrected according to the matching result as shown in FIG. 8C. The following result may be obtained via positioning correction. Information on an accurate direction of the vehicle, that is, heading information may be obtained. Whether a travel direction that is a target of the vehicle is the same direction or an opposite direction to a direction provided by the GPS module 181 of the information provider 180 may be determined. Information on the accurate position of the vehicle may be obtained. Whether a vehicle is positioned in a lane towards a travel direction that is a target of the vehicle or a lane towards an opposite lane may be determined. The vehicle stops, and thus accurate heading information and position information of the vehicle may be calculated using a relatively complex logic or algorithm. In contrast, positioning information needs to be continuously corrected while the vehicle travels, and thus a double configuration using a relatively simple logic may be used.

The detailed map transmission system 170 may reset the initial map provided to the controller 120, may generate a detailed map using the received positioning data, and may transmit the detailed map to the controller 120.

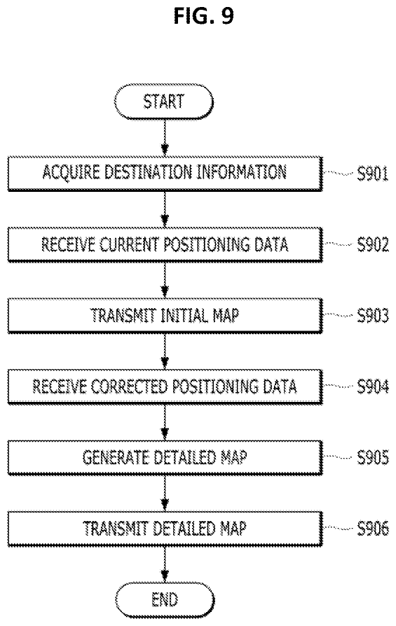

FIG. 9 is a flowchart showing an operation of a detailed map transmission system of an autonomous driving system in some forms of the present disclosure. Thus, in the following description, a subject of an operation may be a detailed map transmission system. First, destination information may be acquired from a data contained in a command for generating an initial map provided from a controller (S901). The current positioning data of the vehicle in a stationary state required to generate the initial map may be received from the information provider 180 (S902). Then, the initial map may be generated based on the received current positioning data and may be transmitted to the controller 120 (S903). The corrected positioning data may be received from the controller 120. In this case, the corrected positioning data may be a result value calculated by matching a temporary map generated using data acquired from a sensor unit of the vehicle with the initial map by the controller 120 (S904). The initial map may be reset, a detailed map may be generated based on the positioning data received from the controller 120 (S905) and may be transmitted to the controller 120 (S906).

As described above, an autonomous driving system and a method of generating a detailed map in some forms of the present disclosure may continuously receive map information required for a travel path appropriate for a destination based on accurate positioning information when a vehicle stops rather than traveling, thereby enabling unmanned driving. Even if information received from a GPS module is information for guiding a vehicle at a position of an opposite lane to a travel lane to travel in an opposite direction or is information for guiding a vehicle at a position of the travel lane to travel in an opposite direction, the vehicle may be assumed to be on an opposite road, or the current lane may be regarded, an initial map may be transmitted base on a travel path, positioning may be corrected, and an existing initial map may be reset to receive accurate map information.

An autonomous driving system and a method of generating a detailed map thereof in some forms of the present disclosure may be a double configuration using a heavy logic for enabling complete treatment because a vehicle does not travel in the case of an initial position and a light logic in the case of positioning correction that is continuously required during traveling.

While the present disclosure has been described referring to the exemplary embodiments of the present disclosure, those skilled in the art will appreciate that many modifications and changes can be made to the present disclosure without departing from the spirit and essential characteristics of the present disclosure.

What is claimed is:

1. An autonomous driving system comprising:
a sensor unit installed in a vehicle and configured to sense first external information and to generate sensing data;
an information provider configured to:
provide second external information required for autonomous driving; and
provide current positioning data of the vehicle in a stationary state;
a vehicle driving unit configured to drive the vehicle;
a controller configured to:
process the first external information and the second external information; and
control the vehicle driving unit; and
a detailed map transmission system configured to:
provide a detailed map of the controller;
provide, to the controller, an initial map generated based on the current positioning data of the vehicle in the stationary state;
receive a corrected positioning data from the controller;
generate the detailed map; and
provide the detailed map to the controller; and
wherein the controller is configured to:
generate a temporary map based on the sensing data;
match the temporary map with the initial map;
correct a positioning data; and
provide the corrected positioning data to the detailed map transmission system.

2. The autonomous driving system of claim 1, wherein the detailed map transmission system is configured to:
generate the initial map based on a most probable path (MPP) based on the current positioning data.

3. The autonomous driving system of claim 2, wherein the detailed map transmission system is configured to:
generate the MPP based only on direction information of the current positioning data; and
generate the MPP using only positioning information of the current positioning data.

4. The autonomous driving system of claim 1, wherein the sensor unit further comprises:
a light detection and ranging (Lidar) configured to:
emit a laser pulse; and
receive light that is reflected by and returns from a target object around the light to measure a distance, an altitude, and a direction of the object;
a radio detection and ranging (radar) configured to:
transmit a radio wave; and
receive a signal of the radio wave to measure the distance, the altitude, and the direction of the object when the radio wave is reflected by a nearby structure;
a camera configured to generate an image of an outside of the vehicle; and
an ultrasonic sensor configured to:
transmit an ultrasonic wave; and
receive a reflected signal to measure the distance, the altitude, and the direction of the object when the ultrasonic wave is reflected by the nearby structure.

5. The autonomous driving system of claim 1, further comprising:
a communicator configured to:
receive destination information from an outside of the vehicle; and
provide the destination information to the controller.

6. The autonomous driving system of claim 5, wherein the communicator further comprises:
a mobile communication module configured to perform data communication using CDMA, GSM, or LTE;
a wireless internet module configured to perform wireless internet communication using WLAN, Wibro, or Wimax; and
a short-distance communication module configured to perform short-distance wireless communication using Bluetooth, NFC, RFID, IrDA, or Zigbee.

7. The autonomous driving system of claim 1, further comprising:
a user interface unit configured to:
receive destination data from a user;
provide the destination data to the controller; and
provide the detailed map to the user.

8. The autonomous driving system of claim 7, wherein the user interface unit further comprises:
an input unit configured to:
receive an input signal of the user; and
transmit the input signal to the controller;
a display unit configured to display information provided from the controller by an image to be recognized by the user;
a microphone configured to transmit the information by a user voice to the controller; and
a sound output unit configured to output the information by an audio signal to be recognized by the user.

9. The autonomous driving system of claim 8, wherein the input unit and the display unit are a touch panel.

10. The autonomous driving system of claim 1, wherein the information provider further comprises:
a global positioning system (GPS) module configured to: receive a signal transmitted from a satellite; and
calculate information on a current position of the vehicle;
a vehicle to everything communication (V2X) module configured to:
exchange information using a wireless or wired communication corresponding to the vehicle; and
transmit the information to the controller;
a geographical information provider configured to provide geographical information required for an operation of the detailed map transmission system; and
a traffic information provider configured to:
receive traffic information provided from an outside of the vehicle; and
transmit the traffic information to the controller.

11. The autonomous driving system of claim 1, wherein the controller is configured to:
correct positioning data based on a travel direction of the vehicle.

12. A method of generating a detailed map of an autonomous driving system, performed by a detailed map transmission system in the autonomous driving system, the method comprising:
acquiring destination information from a controller in the autonomous driving system;
receiving current positioning data of a vehicle in a stationary state from an information provider in the autonomous driving system;
generating an initial map based on the current positioning data;
transmitting the initial map to the controller;
receiving positioning data corrected by matching the initial map and a temporary map generated by the controller using data acquired from a sensor unit of the vehicle;
resetting the initial map based on the corrected positioning data; and
generating a detailed map and transmitting the detailed map to the controller.

13. The method of claim 12, wherein generating the initial map comprises:
generating the initial map based on a most probable path (MPP) using the current positioning data of the vehicle.

14. The method of claim 13, wherein generating the initial map comprises:
generating the MPP based only on direction information of the current positioning data of the vehicle; and
generating the MPP based only on positioning information of the current positioning data of the vehicle.

15. The method of claim 12, wherein acquiring the destination information comprises:
acquiring the destination information in response to a user input through a user interface device.

16. The method of claim 12, wherein acquiring the destination information comprises:
acquiring the destination information from an outside of the vehicle through a communicator.
